(19) United States
(12) Patent Application Publication
(10) Pub. No.: US 2023/0159073 A1
(43) Pub. Date: May 25, 2023

(54) TOTE MOVER

(71) Applicant: Rehrig Pacific Company, Los Angles, CA (US)

(72) Inventors: Derick Foster, Cumming, GA (US); Dane Gin Mun Kalinowski, Foothill Ranch, CA (US); Joseph E. Popovits, II, Costa Mesa, CA (US); Travis James Englert, Brea, CA (US)

(21) Appl. No.: 17/986,561

(22) Filed: Nov. 14, 2022

Related U.S. Application Data
(60) Provisional application No. 63/279,168, filed on Nov. 14, 2021.

(51) Int. Cl. B62B 3/02; B62B 3/06; B66F 9/22; B66F 9/12; B66F 9/14; B66F 9/18

(52) U.S. Cl. CPC B62B 3/02; B62B 3/0612; B62B 3/0618; B66F 9/22; B66F 9/125; B66F 9/122; B66F 9/143; B66F 9/18; B62B 2202/12; B62B 2206/04

(57) ABSTRACT

A tote mover includes a base and a plurality of wheels supporting the base. A backrest is moveable relative to the base. A hook assembly is moveable relative to the backrest between a first rotational position and a second rotational position.

### CROSS-REFERENCE TO RELATED APPLICATIONS

This application claims priority to U.S. Provisional Application No. 63/279,168, which was filed on Nov. 14, 2021 and is incorporated herein by reference.

### BACKGROUND

This disclosure relates to a tote mover for moving a stacked of totes.

Nestable totes fit within each other to reduce the volume needed to transport the totes when empty. However, as more totes are nested in a stack, the weight of the stack can become difficult for a single individual to transport. Therefore, there is a need for a tote mover to assist in moving a stack of nested totes.

### SUMMARY

In one exemplary embodiment, a tote mover includes a base and a plurality of wheels supporting the base. A backrest is moveable relative to the base. A hook assembly is moveable relative to the backrest between a first rotational position and a second rotational position.

In another embodiment according to any of the previous embodiments, the backrest is pivotably attached to the base.

In another embodiment according to any of the previous embodiments, a hydraulic arm is attached to the base and the backrest for pivoting the backrest relative to the base.

In another embodiment according to any of the previous embodiments, the hook assembly is moveable relative to the backrest between a first vertical position and a second different vertical position.

In another embodiment according to any of the previous embodiments, the hook assembly is moveably along a track between the first vertical position and the second vertical position.

In another embodiment according to any of the previous embodiments, the hook assembly includes a center hook located between two spaced-apart hooks.

In another embodiment according to any of the previous embodiments, a distal end of the center hook extends in a first direction. Distal ends of the two spaced-apart hooks extend in a second opposite direction.

In another embodiment according to any of the previous embodiments, the distal end of the center hook and the distal ends of each of the two spaced-apart hooks extend in a common plane parallel to the backrest.

In another embodiment according to any of the previous embodiments, the backrest includes at least one rail pivotably attached to the base on a proximal end and at least one support located adjacent a distal end with the at least one support. The hook assembly is confirmed to maintain a stack of totes parallel to the at least one rail.

In another embodiment according to any of the previous embodiments, the hook assembly is rotatable relative to an axis perpendicular to the backrest between a first position and a second position.

In another embodiment according to any of the previous embodiments, the first rotational position and the second rotational position are positioned 180 degrees relative to each other.

In another embodiment according to any of the previous embodiments, the center hook is aligned evenly spaced between a front pair of wheels of a plurality of wheels.

In another exemplary embodiment, a tote mover includes a base and a plurality of wheels supporting the base. A backrest is moveable relative to the base. A pair of tines are moveable relative to the backrest and the base. Each of the pair of tines is configured to move between a first length and a second length. Each of the pair of tines is configured to move between a first lateral spacing and a second lateral spacing.

In another embodiment according to any of the previous embodiments, an operator platform is pivotably attached to a rearward portion of the base and supported by at least one wheel.

In another embodiment according to any of the previous embodiments, each of the pair of tines are pivotably connected to a corresponding portion of the backrest.

In another embodiment according to any of the previous embodiments, each of the pair of tines are telescopic between the first length and the second different length.

In another embodiment according to any of the previous embodiments, the pair of tines are pivotably attached to the backrest and are moveable between an extended position and collapsed position adjacent the backrest.

In another exemplary embodiment, a method of operating a tote mover includes selecting a rotational position of a hook assembly relative to a backrest to engage one of a single stack of totes or a double stack of totes. A height of the hook assembly is varied to engage a lip on one of the single stack or totes or the double stack of totes. The backrest is tilted relative to a base on the tote mover.

In another embodiment according to any of the previous embodiments, the selection of a rotational position of the hook assembly includes positioning a single hook upward when engaging the single stack of totes or positioning a spaced-apart pair of hooks upward when engaging the double stack of totes.

In another embodiment according to any of the previous embodiments, varying a height of the hook assembly includes moving the hook assembly vertically relative to the backrest along a track.

### BRIEF DESCRIPTION OF THE DRAWINGS

FIG. 1 illustrates a perspective view of an example tote mover according to a first embodiment of the disclosure.

FIG. 2 illustrates a rear perspective view of the tote mover of FIG. 1.

FIG. 3 illustrates a side view of the tote mover of FIG. 1 moving a stack of nestable totes.

FIG. 4 illustrates a rear perspective view of the tote mover of FIG. 1 moving a stack of nestable totes.

FIG. 5 illustrates a hook assembly on the tote mover of FIG. 1 in a first rotational position.

FIG. 6 illustrates the hook assembly on the tote mover of FIG. 1 in an intermediate rotational position.

FIG. 7 illustrates the hook assembly on the tote mover of FIG. 1 in a second rotational position.

FIG. 8 illustrates a perspective view of the tote mover of FIG. 1 with the hook assembly in the second rotational position moving a pair of stacked nestable totes.

FIG. 9 illustrates a perspective view of a tote mover according to a second embodiment of the disclosure carrying a multitude of stacks of nestable totes.

FIG. 10 illustrates a side view of the tote mover of FIG. 9 carrying the multitude of stacks of nestable totes.

FIG. 11 illustrates a pair of tines on the tote mover of FIG. 9 in a retracted position.

FIG. 12 illustrates a pair of tines on the tote mover of FIG. 9 in an extended position.

FIG. 13 illustrates the pair of tines on the tote mover of FIG. 9 in an expanded width position.

FIG. 14 illustrates the pair of tines on the tote mover of FIG. 9 in a reduced width position.

FIG. 15 illustrates a perspective view of the pair of forks on the tote mover of FIG. 9 in a folded position.

FIG. 16 illustrates a perspective view of the pair of forks on the tote mover of FIG. 9 folded downward.

### DETAILED DESCRIPTION

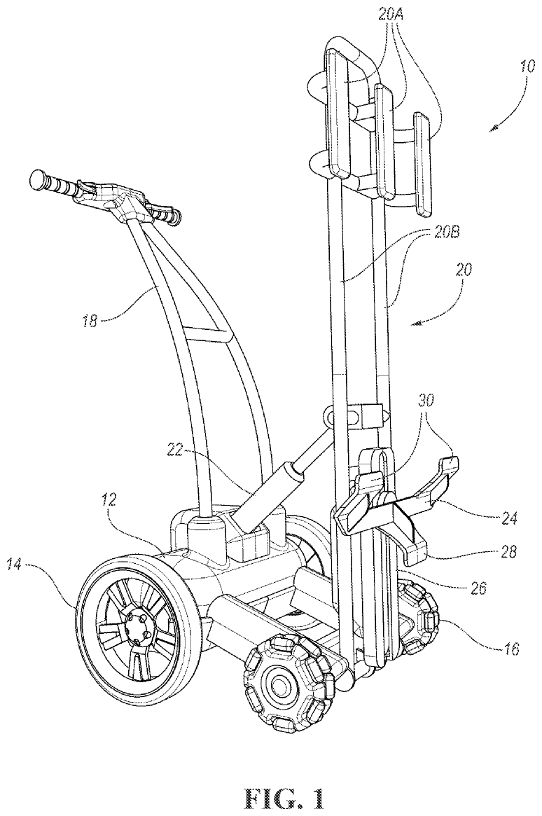

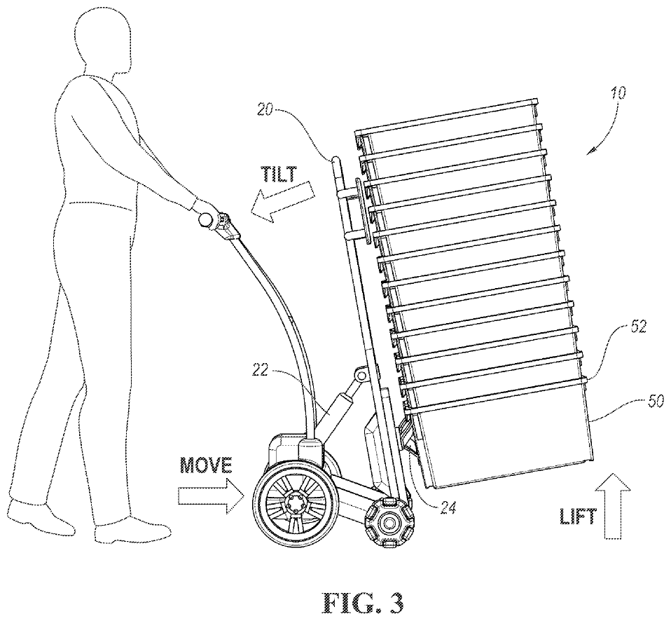

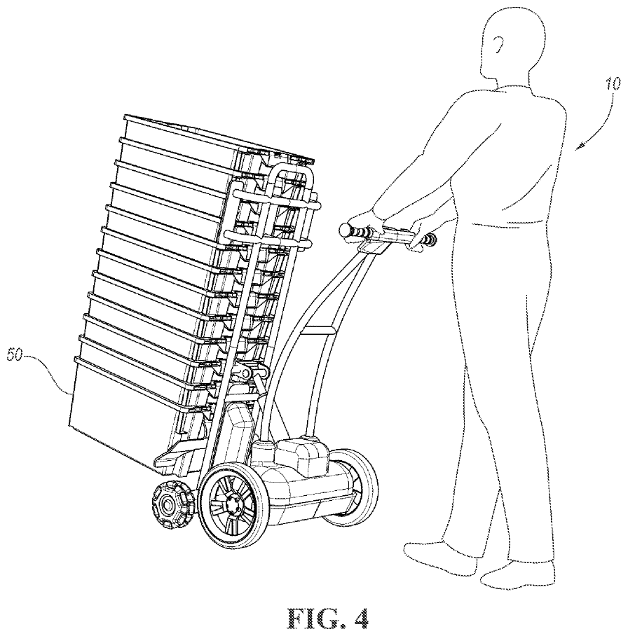

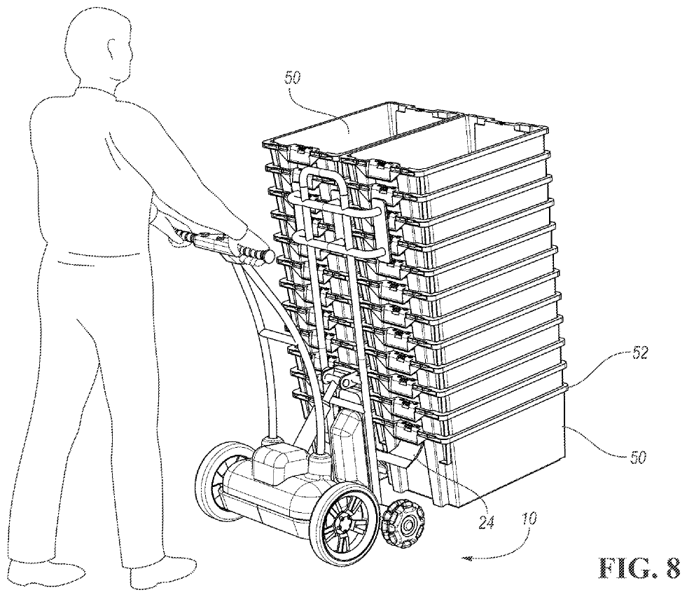

FIG. 1 illustrates a tote mover 10 according to a first example embodiment. One feature of the tote mover 10 is to provide a compact, lightweight, and highly maneuverable piece of equipment that easily picks up and transports either a single stack (FIGS. 3-4) or double stack (FIG. 8) of nestable totes as will be described in more detail below. The overall footprint of the tote mover 10 is very small and the wheelbase is short which allows the tote mover 10 to fit within tight aisleways and easily make sharp turns.

Referring to FIG. 1, the tote mover 10 includes a base 12, which houses a battery, motors, hydraulics, controls, and sensors. A pair of large rear wheels 14 are rotatably mounted to the housing and may be selectively driven by motors in the base 12. A pair of smaller front wheels 16 are also rotatably mounted to the base 12. A handle 18 extends upward and rearward from the base 12 and buttons/switches to provide control to the user for driving and/or lifting.

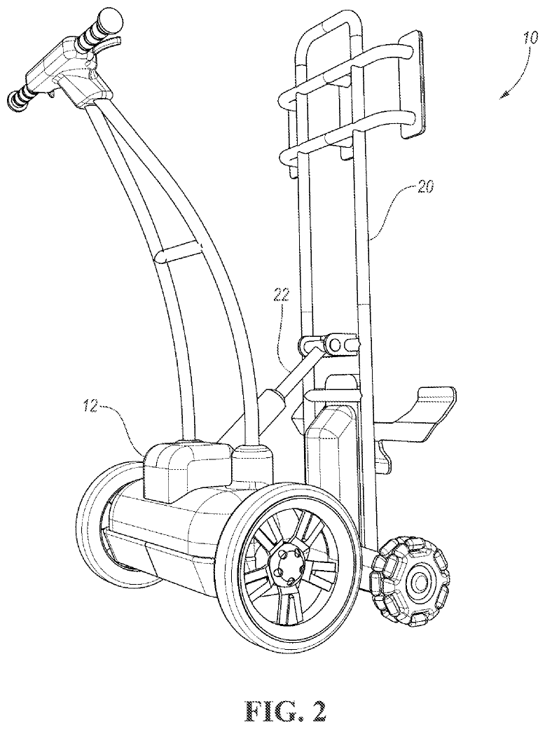

A backrest 20 is pivotably connected to a front of the base 12 and supported by a hydraulic arm 22 mounted to the rear of the base 12. As controlled by the user and/or controls in the base 12, the hydraulic arm 22 extends and retracts to tilt the backrest 20 between a substantially vertical position (FIG. 2) and a position tipped rearward or back (FIG. 3). In the illustrated example, the backrest 20 includes at least one support 20A located adjacent a distal end of backrest 20 and spaced from vertical rails 20B of the backrest 20. The at least one support 20A maintains an equal spacing with a hook assembly or hook 24 to allow a stack of totes 50 to remain parallel to the vertical rails 20B during transport (FIG. 3).

Furthermore, as shown in FIG. 3, when the backrest 20 is in the tipped rearward position, the supports 20A are at least partially horizontally aligned over the base 12 between the pair of rear wheels 14 and the pair of front wheels 16. In this disclosure, being horizontally aligned includes intersecting a plane perpendicular to a work surface supporting the tote mover 10.

A hook 24 is mounted to the backrest 20 and is movable vertically on a track 26 formed on the backrest 20, such as by electric motors or hydraulics. The hook 24 includes a single center hook 28 (extending downward in FIG. 1) and a pair of spaced-apart hooks 30 (extending upward in FIG. 1). The hook 24 can be positioned in two different orientations to pick either a single stack of totes 50 (FIGS. 3-4) or a double stack of totes 50 (FIG. 8) with the different orientations be rotated 180 degrees relative to each other. In the illustrated example, a distal end of the single center hook 28 extends in a first direction and distal ends of the spaced-apart hooks 30 extend in a second opposite direction. Also, the distal end of the single center hook 28 and the distal ends of the spaced-apart hooks 30 are located in a common plane that is parallel to the vertical rails 20B of the backrest 20.

FIG. 2 is a rear perspective view of the tote mover 10. In FIG. 2, the arm 22 is extended, causing the backrest 20 to move to a substantially vertically position.

FIG. 3 shows the tote mover 10 lifting a stack of nestable totes 50. As is common, each tote 50 includes a lip 52 protruding outward and then downward from an upper edge of the periphery of the side walls. As shown in FIG. 3, the hook 24 engages the bottom tote 50 to lift the stack of totes 50. More particularly, the single center hook 28 would be received under and behind the lip 52 of the bottom tote 50. The backrest 20 provides support for the tall stack of totes 50 during transportation. In the illustrated example, a center one of the supports 20A is horizontally aligned with the single center hook 28 and the single center hook 28 engages a region on the lip 52 that forms a handle.

To lift the stack of totes 50, the hook 24 would be moved downward in the track 26 (FIG. 1) and the backrest 20 would be in the substantially vertical position. The hook 24 would be placed adjacent the wall of the bottom tote 50 below the lip 52. The hook 24 is then raised, catching under the lip 52. The backrest 20 then tilts backward by retracting the arm 22. The stack of totes 50 are then supported on the hook 24 and rest against the backrest 20.

FIG. 4 is a rear perspective view of the user and tote mover 10 of FIG. 3. Again, the base 12 may contain motor(s) driving the wheels 14 as controlled by the user. Optionally, the wheels 14 rotate freely so the user can push the tote mover 10.

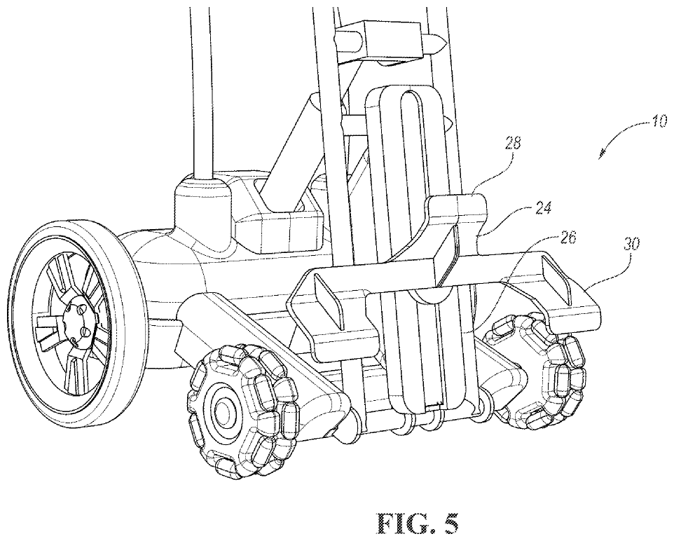

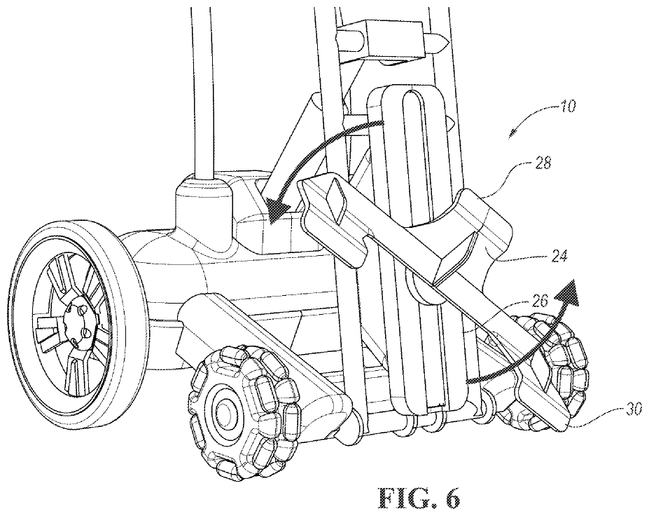

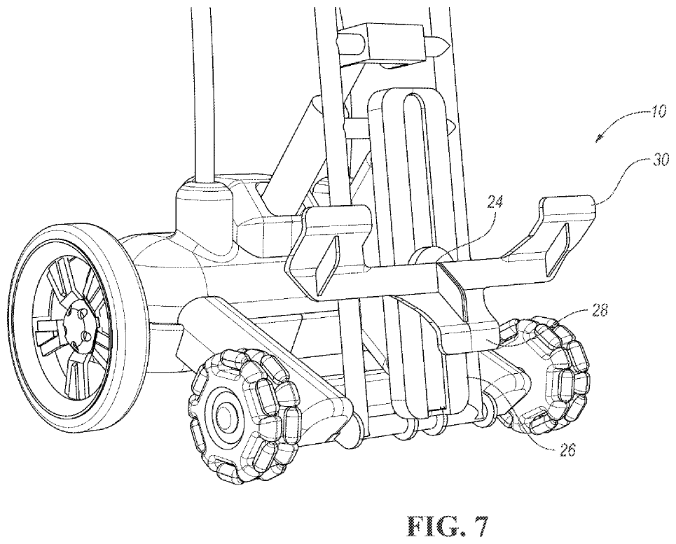

As shown in FIGS. 5-7, the hook 24 may be rotated about an axis perpendicular to the backrest 20. In this manner, the single center hook 28 can extend upward (FIG. 5) or the pair of spaced-apart hooks 30 can extend upward (FIG. 7) when the hook 24 is rotate 180 degrees about the axis.

Referring to FIG. 8, with the pair of spaced-apart hooks 30 extending upward, two adjacent stacks of totes 50 can be lifted and carried at the same time. In the illustrated example, each of the pair of spaced-apart hooks 30 are horizontally aligned with a corresponding one of the supports 20A and the spaced-apart hooks 30 engages a region on the lip 52 that forms a handle.

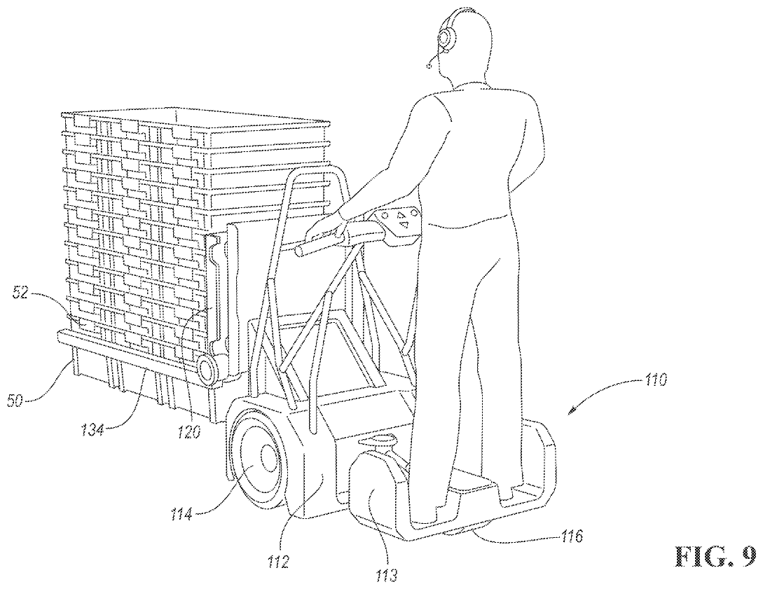

FIG. 9 illustrates a tote mover 110 according to a second example embodiment including a base 112 containing the battery, motors, hydraulics, controls and any sensors, a rear platform 113, and a pair of tines 134. In the illustrated example, the tote mover 110 is a ride-on piece of equipment that provides electro-mechanical assistance to effortlessly pick up and transport multiple stacks of totes 50. The tote mover 110 includes a larger footprint than the tote mover 10, but is able to carry a greater number of totes 50 than the tote mover 10 by engaging a greater number of stacks of totes 50.

The rear platform 113 is pivotably connected to a rearward portion of the base 112 to provide a platform on which the user can stand. Base wheels 114 are pivotably connected to the base 112. Rear wheels 116 support the rear platform 113 on a floor surface. The base wheels 114 are driven by motors within the base 112 as controlled by the user.

One feature of the rear platform 113 is to provide a standing ride platform for the operator to have a safe and secure space to stand while driving the tote mover 110. The raised platform also elevates the operator, offering a clear line of sight over the stack of totes 50. Similar to the tote mover 10, the powered systems on the tote mover 110 are controlled through buttons/switches mounted on the ergonomic handlebars 118.

A pair of tines 134 extend forward of the base 112 and can be raised and lowered relative to the base 112 (such as via electric motors or hydraulics or manually-activated leverage). A backrest 120 extends vertically upward from a rear end of each of the tines 134 and is raised and lowered with the tines 134.

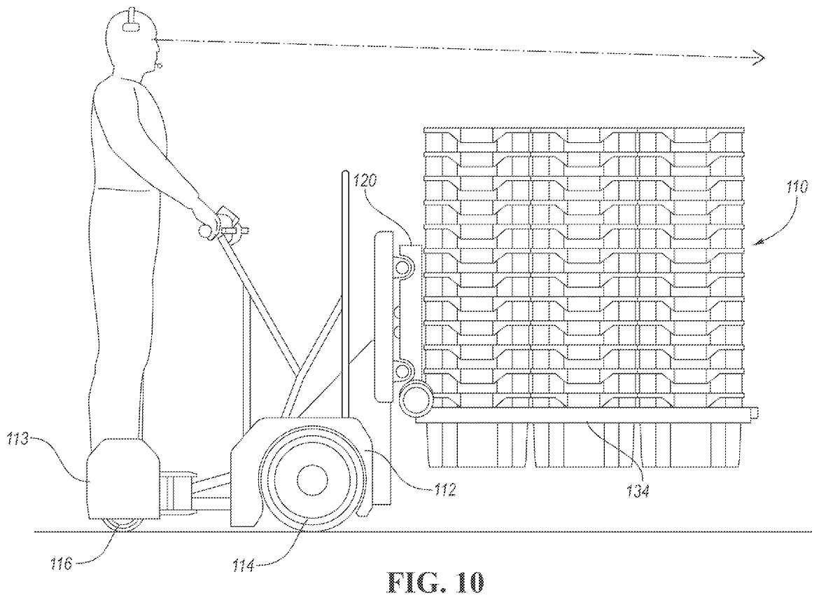

As shown in FIG. 10, the tines 134 can lift several stacks of totes 50 by being positioned under the lips 52 of the bottom totes 50. The tines 134 also engage a larger bottom edge portion of the lip 52 that the hook 24. In one example, the tines 134 engage a lower edge of the lip 52 along the entire length of opposing sides of the tote 50. By standing on the rear platform 116, the user has visibility over the totes 50.

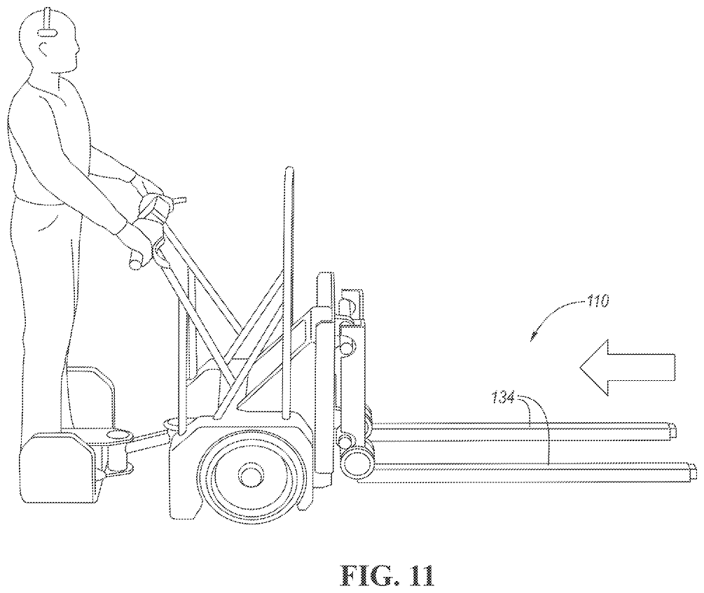

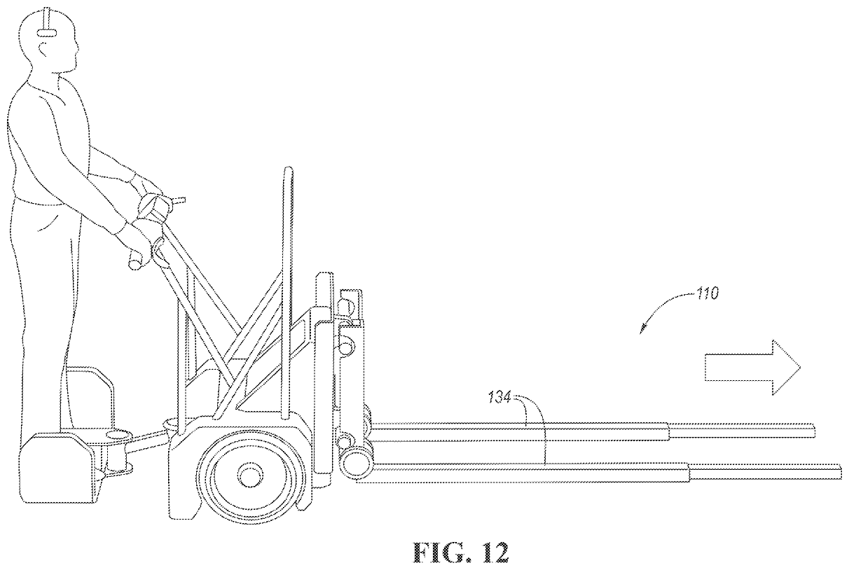

FIGS. 11 and 12 show a first option for the tote mover 110. As shown, the tines 134 each include a telescoping portion than can be extended (FIG. 12) or retracted (FIG. 11), as controlled by the user via hydraulics, motors or other actuators.

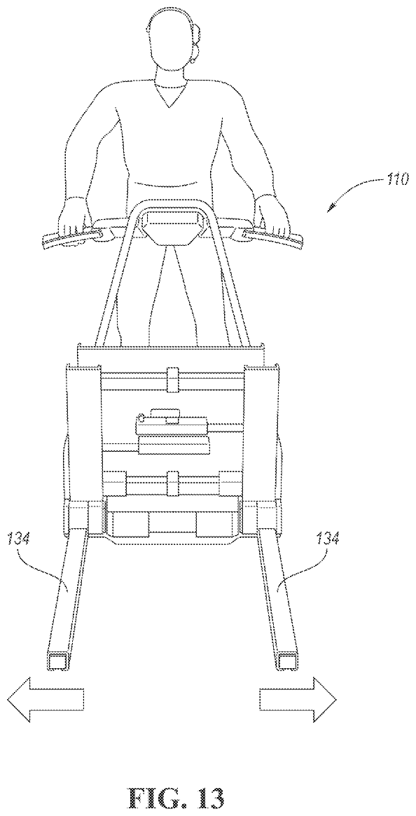

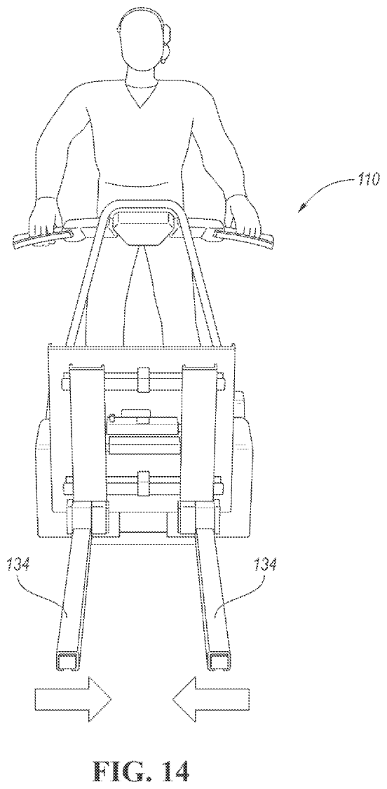

FIGS. 13 and 14 show a second option for the tote mover 110. As shown, the tines 134 can be moved toward and away from one another. In this manner, the tines 134 can accommodate the totes 50 in either orientation of the totes 50 (e.g. width or length). Alternatively, the tines 134 can be adjusted to accommodate different size totes. The two positions may be programmed into the tote mover 110 controls, so that the user can simply select between the two positions. The tines 134 may be mounted on rails and may be moved by electric motors or hydraulics or other actuators.

The powered expansion/retraction system for the pair of fork tines 134 allows the pair of tines 134 to expand and retract in two directions—along the length and width. This creates varying lengths and lateral spacings for the pair of tines 134. The expansion/retraction system allows the tote mover 110 to pick multiple stacks of totes 50 along the length of the unit, as well as being able to pick the rectangular-shaped totes 50 on the long side or short side.

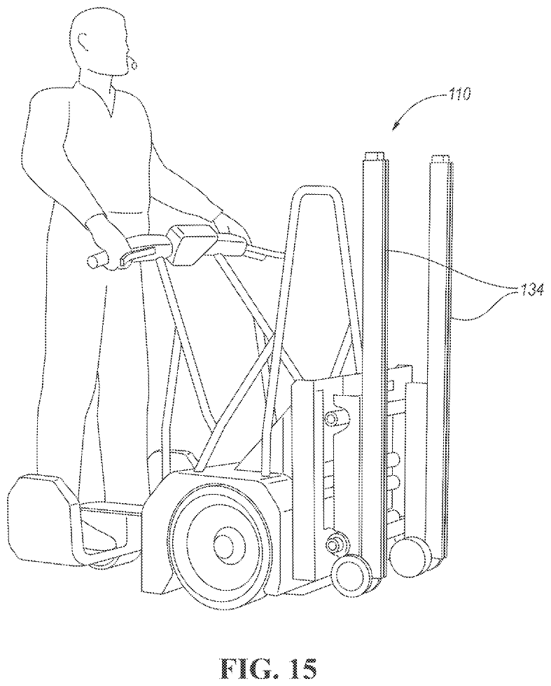

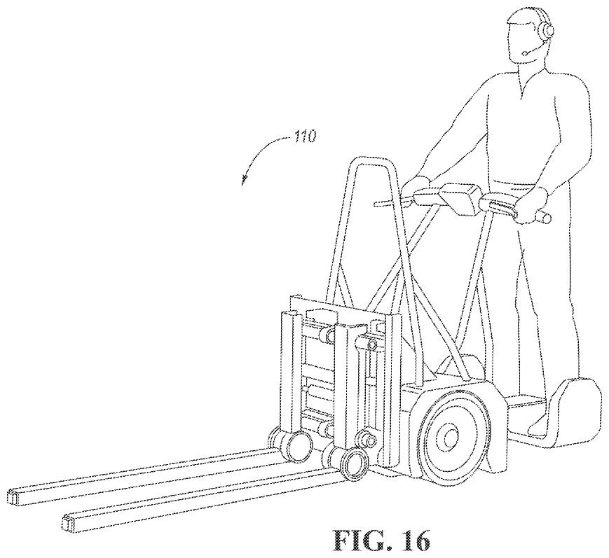

FIGS. 15 and 16 show a third option for the tote mover 110. As shown, the tines 134 can be folded upward against the backrest 120 for maneuverability and storage when not being used (FIG. 15). The tines 134 can then be folded downward for use (FIG. 16).

Although the different non-limiting examples are illustrated as having specific components, the examples of this disclosure are not limited to those particular combinations. It is possible to use some of the components or features from any of the non-limiting examples in combination with features or components from any of the other non-limiting examples.

It should be understood that like reference numerals identify corresponding or similar elements throughout the several drawings. It should also be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claim should be studied to determine the true scope and content of this disclosure.

What is claimed is:

1. A tote mover comprising:
a base;
a plurality of wheels supporting the base;
a backrest moveable relative to the base; and
a hook assembly moveable relative to the backrest between a first rotational position and a second rotational position.

2. The tote mover of claim 1, wherein the backrest is pivotably attached to the base.

3. The tote mover of claim 2, including a hydraulic arm attached to the base and the backrest for pivoting the backrest relative to the base.

4. The tote mover of claim 2, wherein the hook assembly is moveable relative to the backrest between a first vertical position and a second different vertical position.

5. The tote mover of claim 4, wherein the hook assembly is moveably along a track between the first vertical position and the second vertical position.

6. The tote mover of claim 1, wherein the hook assembly includes a center hook located between two spaced-apart hooks.

7. The tote mover of claim 6, wherein a distal end of the center hook extends in a first direction and distal ends of the two spaced-apart hooks extend in a second opposite direction.

8. The tote mover of claim 7, wherein the distal end of the center hook and the distal ends of each of the two spaced-apart hooks extend in a common plane parallel to the backrest.

9. The tote mover of claim 8, wherein the backrest includes at least one rail pivotably attached to the base on a proximal end and at least one support located adjacent a distal end with the at least one support and the hook assembly confirmed to maintain a stack of totes parallel to the at least one rail.

10. The tote mover of claim 6, wherein the hook assembly is rotatable relative to an axis perpendicular to the backrest between a first position and a second position.

11. The tote mover of claim 8, wherein the first rotational position and the second rotational position are positioned 180 degrees relative to each other.

12. The tote mover of claim 6, wherein the center hook is aligned evenly spaced between a front pair of wheels of the plurality of wheels.

13. A tote mover comprising:
a base;
a plurality of wheels supporting the base;
a backrest moveable relative to the base; and
a pair of tines moveable relative to the backrest and the base, wherein each of the pair of tines is configured to move between a first length and a second length and each of the pair of tines is configured to move between a first lateral spacing and a second lateral spacing.

14. The tote mover of claim 13, including an operator platform pivotably attached to a rearward portion of the base and supported by at least one wheel.

15. The tote mover of claim 14, wherein each of the pair of tines are pivotably connected to a corresponding portion of the backrest.

16. The tote mover of claim 15, wherein each of the pair of tines are telescopic between the first length and the second different length.

17. Three tote mover of claim 13, wherein the pair of tines are pivotably attached to the backrest and are moveable between an extended position and collapsed position adjacent the backrest.

18. A method of operating a tote mover comprising:
selecting a rotational position of a hook assembly relative to a backrest to engage one of a single stack of totes or a double stack of totes;
varying a height of the hook assembly to engage a lip on one of the single stack or totes or the double stack of totes; and
tilting the backrest relative to a base on the tote mover.

19. The method of claim 18, wherein selecting a rotational position of the hook assembly includes positioning a single hook upward when engaging the single stack of totes or positioning a spaced-apart pair of hooks upward when engaging the double stack of totes.

20. The method of claim 18, wherein varying a height of the hook assembly includes moving the hook assembly vertically relative to the backrest along a track.
